(19) United States
(12) Patent Application Publication
(10) Pub. No.: US 2025/0383026 A1
(43) Pub. Date: Dec. 18, 2025

(54) Pressure Relief Assembly with Detent

(71) Applicant: Donaldson Company, Inc., Bloomington, MN (US)

(72) Inventors: Matthew J. Goode, Blaine, MN (US); Daniel J. Dotzler, Webster, MN (US)

(21) Appl. No.: 19/237,893

(22) Filed: Jun. 13, 2025

Related U.S. Application Data
(60) Provisional application No. 63/660,938, filed on Jun. 17, 2024.

(51) Int. Cl. F16K 17/04

(52) U.S. Cl. CPC F16K 17/0406

(57) ABSTRACT

A pressure relief assembly has a frame having a coupling structure and a valve opening within the valve mounting surface. A valve body has an extension portion extending axially from a sealing rim through the valve opening to a first end of the valve body. In some embodiments, opposite first and second detent engagement surfaces releasably engage the valve body to the frame. The frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end. in some embodiments a first detent ball is translatably disposed in a detent channel and does not make contact with the channel wall.

The present disclosure claims the benefit of U.S. provisional application 63/660,938 filed on Jun. 17, 2024, which is incorporated by reference herein in its entirety.

### TECHNOLOGICAL FIELD

The present disclosure is generally related to a pressure relief assembly. More particularly, the present disclosure is related to a pressure relief assembly with a detent.

### SUMMARY

Some embodiments of the technology disclosed herein relate to a pressure relief assembly. The pressure relief assembly has a frame having a coupling structure, a valve mounting surface, and a valve opening within the valve mounting surface. The valve opening extends axially from the valve mounting surface. The pressure relief assembly has a valve. The valve has a valve body having a sealing rim sealably disposed on the valve mounting surface across the valve opening. The valve body has an extension portion extending axially from the sealing rim through the valve opening to a first end of the valve body. The pressure relief assembly has a first detent engagement surface releasably engaging the valve body to the frame. The pressure relief assembly has a second detent engagement surface releasably engaging the valve body to the frame. The second detent engagement surface opposite the first detent engagement surface relative to the valve body. The frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end.

In some such embodiments, the pressure relief assembly has the first detent engagement surface extends laterally outward from the valve body and releasably engages the frame, and the second detent engagement surface extends laterally outward from the valve body and releasably engages the frame. Additionally or alternatively, the extension portion is tapered laterally inward from the valve opening to the first end of the valve body. Additionally or alternatively, the pressure relief assembly further has a first lip surrounding the first detent engagement surface. The first detent engagement surface protrudes laterally outward from the first lip, the first lip retains the first detent engagement surface relative to the valve body, and a first portion of the lip is laterally inward from a second portion of the first lip. Additionally or alternatively, the first lip is defined by the valve body. Additionally or alternatively, the first lip is defined by a detent housing coupled to the valve body. Additionally or alternatively, the first portion of the first lip is positioned towards a first axial end of the pressure relief assembly compared to the second portion of the first lip.

Additionally or alternatively, the pressure relief assembly further has a first detent releasably securing the valve body to the frame. Additionally or alternatively, the first detent has a first detent housing having a first end and an open second end, a compression spring is disposed in the first detent housing, the compression spring extending from the first end towards the open second end. The first detent engagement surface is translatably disposed in the first detent housing. The compression spring is compressibly disposed between the first detent engagement surface and the first end of the first detent housing. Additionally or alternatively, the valve body has a detent opening extending laterally outward from a central axis x, and the first detent is disposed in the detent opening. Additionally or alternatively, a compression spring is compressibly disposed between the first detent engagement surface and the second detent engagement surface.

Additionally or alternatively, the pressure relief assembly further has a first detent ball. The first detent ball releasably engages the valve body to the frame. The first detent ball defines an outer surface. The outer surface does not make contact with the valve body. Additionally or alternatively, the frame has a vent mounting surface, and a vent opening within the vent mounting surface. The vent opening defines a vent airflow pathway that is functionally parallel to a valve airflow pathway defined by the valve opening and the pressure relief assembly further has a vent coupled to the vent mounting surface across the vent opening. Additionally or alternatively, the pressure relief assembly further has a vent. The valve body has a vent mounting surface and a vent opening within the vent mounting surface. The vent opening defines a vent airflow pathway that is functionally parallel to a valve airflow pathway defined by the valve opening, and the vent is coupled to the vent mounting surface across the vent opening. Additionally or alternatively, the vent opening is geometrically parallel to the valve opening.

Additionally or alternatively, the pressure relief assembly further has a vent cover extending laterally across the vent. The vent is positioned axially between the frame and the vent cover. Additionally or alternatively, the pressure relief assembly further defines an environmental opening perpendicular to the vent cover. Additionally or alternatively, the environmental opening is positioned axially between the vent cover and the vent. Additionally or alternatively, the vent is a breathable membrane. Additionally or alternatively, the valve body has a circular profile in the lateral direction. Additionally or alternatively, the valve has a valve sidewall around the vent opening and the frame has a frame sidewall around the valve opening. The frame sidewall is spaced laterally outward from the valve sidewall.

Some embodiments of the technology disclosed herein relate to a pressure relief assembly having a frame, a valve, and a first detent ball. The frame has a coupling structure, a valve mounting surface, and a valve opening within the valve mounting surface. The valve opening extends axially from the valve mounting surface. The valve has a valve body having a sealing rim sealably disposed on the valve mounting surface across the valve opening. The first detent ball translatably disposed in a detent channel having a channel wall. The first detent ball releasably engages the valve body to the frame. The first detent ball defines an outer surface. The outer surface does not make contact with the channel wall.

In some such embodiments, the valve body has an extension portion extending axially from the sealing rim through the valve opening to a first end of the valve body. Additionally or alternatively, the pressure relief assembly further has a first detent engagement surface releasably engaging the valve body to the frame. Additionally or alternatively, the pressure relief assembly further has a second detent engagement surface releasably engaging the valve body to the frame. The second detent engagement surface opposite the first detent engagement surface relative to the valve body. Additionally or alternatively, the frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end. Additionally or alternatively, the first detent engagement surface extends laterally outward from the valve body and releasably engages the frame, and the second detent engagement surface extends laterally outward from the valve body and releasably engages the frame. Additionally or alternatively, the extension portion is tapered laterally inward from the valve opening to the first end of the valve body.

Additionally or alternatively, the pressure relief assembly further has a first lip surrounding the first detent engagement surface. The first detent engagement surface protrudes laterally outward from the first lip, the first lip retains the first detent engagement surface relative to the valve body, and a first portion of the first lip is laterally inward from a second portion of the first lip. Additionally or alternatively, the first lip is defined by the valve body. Additionally or alternatively, the first lip is defined by a detent housing coupled to the valve body. Additionally or alternatively, the first portion of the first lip is positioned towards a first axial end of the pressure relief assembly compared to the second portion of the first lip. Additionally or alternatively, the pressure relief assembly further has a first detent releasably securing the valve body to the frame.

Additionally or alternatively, the first detent has a first detent housing having a first end and an open second end. A compression spring is disposed in the first detent housing. The compression spring extends from the first end towards the open second end. The first detent engagement surface is translatably disposed in the first detent housing. The compression spring is compressibly disposed between the first detent engagement surface and the first end of the first detent housing. Additionally or alternatively, the valve body has a detent opening extending laterally outward from a central axis x, and the first detent is disposed in the detent opening. Additionally or alternatively, a compression spring is compressibly disposed between the first detent engagement surface and the second detent engagement surface. Additionally or alternatively, the frame has a vent mounting surface, and a vent opening within the vent mounting surface. The vent opening defines a vent airflow pathway that is functionally parallel to a valve airflow pathway defined by the valve opening and the pressure relief assembly further has a vent coupled to the vent mounting surface across the vent opening.

Additionally or alternatively, the pressure relief assembly further has a vent. The valve body has a vent mounting surface and a vent opening within the vent mounting surface. The vent opening defines a vent airflow pathway that is functionally parallel to a valve airflow pathway defined by the valve opening, and the vent is coupled to the vent mounting surface across the vent opening. Additionally or alternatively, the vent opening is geometrically parallel to the valve opening. Additionally or alternatively, the pressure relief assembly further has a vent cover extending laterally across the vent. The vent is positioned axially between the frame and the vent cover. Additionally or alternatively, the pressure relief assembly further defines an environmental opening perpendicular to the vent cover. Additionally or alternatively, the environmental opening is positioned axially between the vent cover and the vent. Additionally or alternatively, the vent is a breathable membrane. Additionally or alternatively, the valve body has a circular profile in the lateral direction. Additionally or alternatively, the valve has a valve sidewall around the vent opening and the frame has a frame sidewall around the valve opening. The frame sidewall is spaced laterally outward from the valve sidewall.

Some embodiments relate to a pressure relief assembly having a valve with a valve body having a sealing rim sealably configured to seal across a valve opening, where the valve body defines a detent channel extending laterally across the valve body. A spring is disposed in the detent channel, and the spring defines a first end and a second end. The spring is compressibly disposed between a first detent ball and a second detent ball opposite the first detent ball relative to the valve body.

In some such embodiments, the assembly has a frame having a coupling structure, a valve mounting surface, and the valve opening within the valve mounting surface. The valve opening extends axially from the valve mounting surface. The sealing rim is sealably disposed on the valve mounting surface across the valve opening. The first detent ball and the second detent ball releasably engages the frame. Additionally or alternatively, the valve body has a vent mounting surface and a vent opening within the vent mounting surface, and the pressure relief assembly further has a vent coupled to the vent mounting surface across the vent opening. Additionally or alternatively, a vent cover extends laterally across the vent, where the vent is positioned axially between the vent and the vent cover.

Additionally or alternatively, the valve includes a valve sidewall around the vent opening and the frame has a frame sidewall around the valve opening, where the frame sidewall is spaced laterally outward from the valve sidewall. Additionally or alternatively, the valve body has an extension portion extending axially from the sealing rim to a first end of the valve body, and where the extension portion defines the detent channel. Additionally or alternatively, the frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end.

Additionally or alternatively, the outer surface of the first detent ball and the second detent ball does not make contact with a channel wall defining the detent channel. Additionally or alternatively, the extension portion is tapered laterally inward from the valve opening to the first end of the valve body. Additionally or alternatively, the first detent ball defines a first detent engagement surface, and the assembly has a first lip surrounding the first detent engagement surface, wherein the first detent engagement surface protrudes laterally outward from the first lip, the first lip retains the first detent engagement surface relative to the valve body, and a first portion of the first lip is laterally inward from a second portion of the first lip. Additionally or alternatively, the first lip is defined by the valve body. Additionally or alternatively, the first portion of the first lip is positioned towards a first axial end of the pressure relief assembly compared to the second portion of the first lip.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 is a cross-sectional view of an example pressure relief assembly consistent with the technology disclosed herein.

FIG. 2 is a cross-sectional view of the example valve of FIG. 1.

FIG. 3 is a detail view of a portion of FIG. 1.

FIG. 4 is an exploded perspective cross-sectional view of another example pressure relief assembly.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

Pressure relief assemblies consistent with the technology disclosed herein are generally configured to provide pressure relief to an enclosure when the pressure within the enclosure exceeds a minimum pressure differential relative to an environment outside of the enclosure.

The pressure relief assembly is generally configured to be coupled to the enclosure, where the enclosure is generally not a component of the pressure relief assembly. The pressure relief assembly can be configured to facilitate selective pressure equalization of the enclosure while preventing the entry of contaminants, such as particles and liquids (such as water), into the enclosure. The enclosure is generally configured to house system components such as electronic components and battery cells, as examples. In some examples, the enclosure is a battery housing.

Some embodiments of the technology disclosed herein may advantageously allow re-use of the pressure relief assembly after release of the pressure relief valve. In particular, detents that can be used to release the pressure relief valve may be configured to be deployed multiple times without mechanical/physical degradation, which allows for a predictable minimum pressure differential to trigger deployment of the valve. The reusability of the pressure relief assembly may advantageously allow performance testing of every component prior to use by an end customer, for example. The reusability of the pressure relief assembly may advantageously allow re-use by an end customer, as another example.

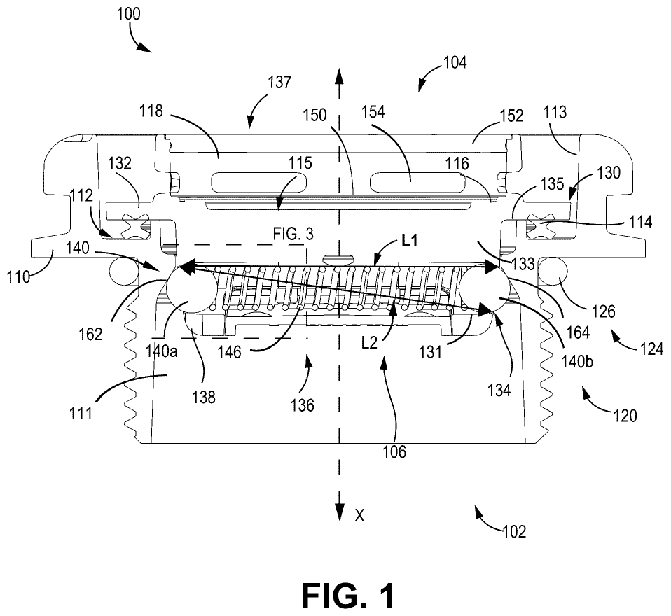

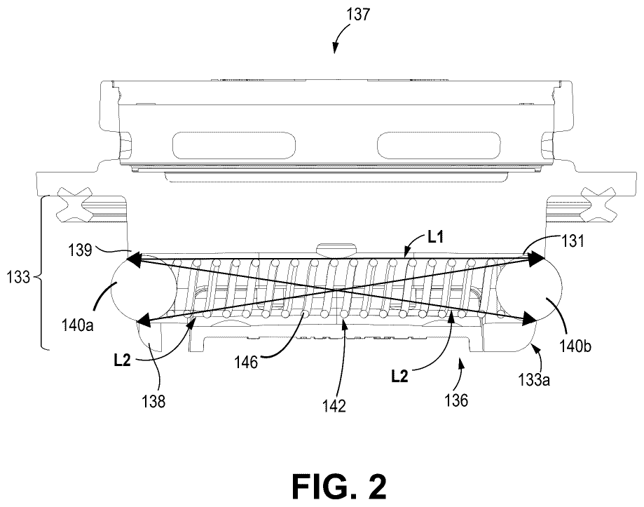

FIGS. 1-2 depict one example pressure relief assembly 100 consistent with the technology disclosed herein, which can be viewed together in conjunction with the following description. FIG. 1 is a cross-sectional view of the example pressure relief assembly 100, and FIG. 2 is a cross-sectional view of the example valve 130 denoted in FIG. 1.

The pressure relief assembly 100 is generally configured to be coupled to an enclosure about an opening in the enclosure. The pressure relief assembly 100 generally has a first axial end 102, a second axial end 104, and a valve airflow pathway 106 extending from the first axial end 102 towards the second axial end 104. The valve airflow pathway 106 is selectively obstructed by a valve 130, where the valve 130 is configured to relieve pressure when the pressure within the enclosure exceeds a minimum pressure differential relative to the environment outside of the enclosure.

The pressure relief assembly 100 has a frame 110 and the valve 130 is coupled to the frame 110. The frame 110 is generally configured to support one or more components of the pressure relief assembly 100. The frame 110 has a coupling structure 120, a valve mounting surface 112, and a valve opening 111 within the valve mounting surface 112. The valve airflow pathway 106 selectively extends through the valve opening 111. The valve opening 111 extends axially from the valve mounting surface 112.

The valve 130 is generally configured to accommodate pressure release from an enclosure to which the pressure relief assembly 100 is coupled. The valve 130 is generally configured to accommodate pressure release from the first axial end 102 to the second axial end 104 through the frame 110. The valve 130 has a valve body 132 sealably disposed on the valve mounting surface 112 across the valve opening 111. As such, the valve airflow pathway 106 is obstructed by the valve body 132. The valve body 132 can be constructed of a variety of materials and combinations of materials including plastic, metal, wood, and the like. The material forming the valve body 132 is generally non-breathable and liquid impermeable. Non-breathable is used here to mean that there is no measurable airflow through the material forming the valve body 132 at room temperature with at least 20 mbar pressure differential across the valve body 132.

The valve body 132 has a sealing rim 135 sealably disposed on the valve mounting surface 112 across the valve opening 111. In the current example, the valve body 132 has an extension portion 133 extending axially from the sealing rim 135 through the valve opening 111 to a first end 136 of the valve body 132. The sealing rim 135 extends laterally outward from the extension portion 133.

In the current example, the frame 110 defines the valve mounting surface 112. The valve mounting surface 112 is configured to sealably receive the valve 130 around the valve opening 111. The valve 130 and the vent 150 selectively obstruct the valve airflow pathway 106. In the current example, the valve 130 includes a sealing component 114 that is configured to form a seal with the valve mounting surface 112. In some other embodiments, the valve mounting surface 112 includes the sealing component 114 that is configured to form a seal with the valve 130.

The valve body 132 can have a variety of different shapes, but in the current embodiment the valve body 132 has a circular profile in the lateral direction, where the “lateral direction” is the direction of the plane perpendicular to the axial direction, and the axial direction is the direction of a central axis x (FIG. 1) of the assembly 100 extending between the first axial end 102 and the second axial end 104. In some embodiments, the valve body 132 can have a lateral profile that is a polygonal shape such as rectangular, square, hexagonal, or the like.

The pressure relief assembly 100 generally has a first detent engagement surface 162 and a second detent engagement surface 164. The first detent engagement surface 162 and the second detent engagement surface 164 each releasably engage the valve body to the frame 110. The first detent engagement surface 162 and the second detent engagement surface 164 are generally configured to release the valve body 132 from the frame 110 upon a minimum pressure differential across the valve opening 111. In the current example, the first detent engagement surface 162 is coupled to the valve body 132 and releasably engages the frame 110. Similarly, in the current example, the second detent engagement surface 164 is coupled to the valve body 132 and releasably engages the frame 110. However, in some other embodiments the first detent engagement surface 162 and the second detent engagement surface 164 are coupled to the frame and releasably engage the valve body 132.

In the current example, the first detent engagement surface 162 extends laterally outward from the extension portion 133 and the second detent engagement surface 164 extends laterally outward from the extension portion 133. In some other embodiments the first detent engagement surface 162 and the second detent engagement surface 164 can extend laterally outward from the sealing rim 135 or a portion of the valve body between the sealing rim 135 and a second end 137 of the valve body to releasably engage the frame 110. In some other embodiments, the first detent engagement surface 162 and the second detent engagement surface 164 extend laterally inward from the frame to releasably engage the valve body. In the current example, the second detent engagement surface 164 is opposite the first detent engagement surface 162 relative to the extension portion 133.

In the current example, the first detent engagement surface 162 and the second detent engagement surface are defined by a detent 140 that releasably engages the valve body 132 relative to the frame 110. A detent is defined herein as a mechanical or magnetic structure that secures a first part to a second part and releases the first part from the second part upon a particular release force being applied to the first part. In accordance with the technology disclosed herein, the “first part” is generally the valve body 132, and the release force that is generally applied to the valve body 132 is the pressure differential between an enclosure that the assembly is coupled to and the environment outside of the enclosure.

The detent 140 can have a variety of configurations. In the current example, the detent is a spring-loaded detent. A spring-loaded detent is a detent that employs a compression spring to secure the valve 130 to the frame 110 and the spring force is overcome by the release force to release the valve 130 from the frame 110. Each detent extends laterally from the frame 110 to the valve body 132. The detent 140 is fixed to the valve body 132 and each detent engagement surfaces frictionally engages the frame 110, although the reverse configuration is also possible where each detent 140 is fixed to the frame 110 and frictionally engages the valve body 132. Furthermore, other types of engagement are possible such as magnetic engagement.

In the current example, the detent has a first detent ball 140a, a second detent ball 140b. A compression spring 146 is compressibly disposed between the first detent ball 140a and the second detent ball 140b. In the current example, the first detent engagement surface 162 is defined by the first detent ball 140a disposed in a detent opening 134, and the second detent engagement surface 164 is defined by the second detent ball 140b disposed in the detent opening 134. The detent balls 140a and 140b can be a sphere translatably disposed in the detent opening 134 to facilitate release of the valve body 132 by the frame 110. In some other embodiments, the detent engagement surface can be defined by a differently-shaped component, such as an ovoid or a cylindrical component with a rounded, convex end forming the detent engagement surface. In some other embodiments, the detent engagement surface is concave.

In the current example, the valve body 132 defines the detent opening 134, which is a detent channel that translatably receives the detent 140. The valve body 132 defines a channel wall 131 that surrounds the detent channel/channel opening 134. The detent opening 134 extends laterally outward from the central axis x. In this particular example, the detent opening 134 extends laterally across the valve body 132. The first detent ball 140a, the compression spring 146, and the second detent ball 140b are disposed in the detent opening 134. The compression spring 146 can be a helical coil constructed of metal or plastic, in some embodiments. The compression spring 146 can also be multiple coils, in some embodiments. The first detent engagement surface 162 is defined by the outer surface of the first detent ball 140a that extends outside of the detent opening 134. Similarly, the second detent engagement surface 164 is defined by the outer surface of the second detent ball 140b that is positioned outside of the detent opening 134.

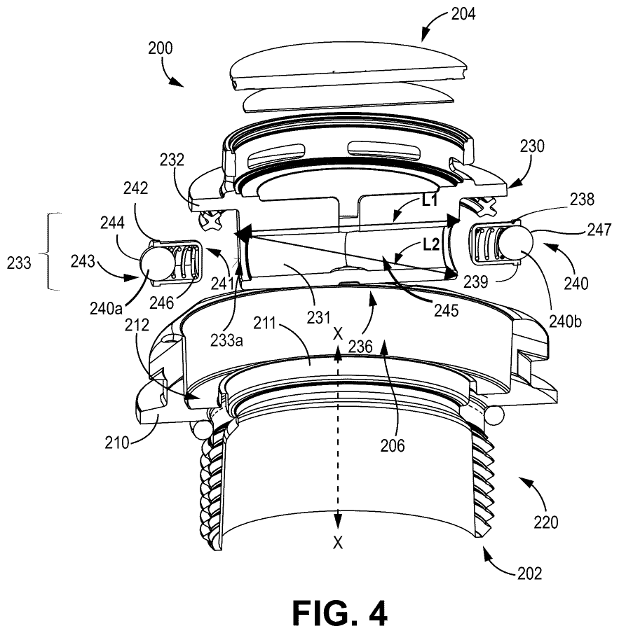

In the current example, the pressure relief assembly 100 further has a first lip 138 surrounding the first detent engagement surface 162. A “lip” is defined as the portion of the channel wall surrounding the detent engagement surface. The pressure relief assembly 100 further has a second lip 139 surrounding the second detent engagement surface 164. The lip 138, 139 is generally configured to retain the detent engagement surface 162, 164 relative to the valve body 132. The first detent engagement surface 162 protrudes laterally outward from the first lip 138. The second detent engagement surface 164 protrudes laterally outward from the second lip 139. The lip 138, 139 can be configured to retain the detent engagement surface 162, 164 relative to the valve body 132 particularly when the valve body 132 is uncoupled from the frame 110. In some embodiments, the lip 138, 139 is defined by the valve body 132. In some other embodiments, the lip 138, 139 is defined by a detent housing coupled to the valve body 132, which will be described in more detail below with respect to FIG. 4.

When the pressure in an enclosure increases to attain a minimum pressure differential between the enclosure and the outside environment, the force between the frame 110 and the detent engagement surface 162/164 increases until the biasing force of the compression spring 146 is overcome, causing lateral translation of the detent ball 140a, 140b against the compression spring 146, towards the opposite side of the engagement surface 162/164. The pressure differential between the enclosure and the outside environment results in a force that pushes the valve body 132 out from the valve opening 111, which is unopposed by the detent 140.

In various implementations, both the first detent engagement surface 162 and the second detent engagement surface 164 are configured to release the valve body 132 from the frame 110 upon a minimum pressure differential across the valve opening 111. However, in the course of testing it has been discovered that under real world conditions the first detent engagement surface and the second detent engagement surface may not release the valve body 132 from the frame 110 perfectly simultaneously. Indeed, one of the first detent engagement surface 162 or the second detent engagement surface 164 may release the valve body 132 from the frame 110 prior to the other detent engagement surface upon a minimum pressure differential across the valve opening 111.

When the pressure inside the enclosure spikes above a minimum pressure differential between inside the enclosure and the outside environment, the pressure inside the enclosure pushes against the enclosure side of the valve body 132, which deploys either the first detent ball 140a, the second detent ball 140b, or both to decouple the valve body 132 from the valve mounting surface 112. The valve body 132 can either (1) be released from the frame 110 (where all detent balls disengage the valve body from the frame simultaneously) or (2) pivot about the valve opening at a point opposite the disengaged detent engagement surface to clear the valve airflow pathway 106 and allow pressure equalization across the valve airflow pathway 106.

The frame 110 generally has an inner minimum cross-dimension L1 that extends laterally across the valve opening 111. The inner minimum cross-dimension L1 can extend in a direction parallel to the direction from the first detent engagement surface 162 to the second detent engagement surface 164. In embodiments such as that depicted in FIG. 1, the extension portion 133 of the valve body 132 generally has a corresponding cross-dimension that is less than the inner minimum cross-dimension L1 of the valve opening 111. Furthermore, the valve body 132 is generally configured to avoid interference with the frame in the event of a single detent engagement surface 162, 164 disengaging the valve body 132 from the frame 110. In particular, the inner minimum cross-dimension L1 of the valve opening is greater than or equal to the distance L2 from an end point of the inner minimum cross-dimension to the outer surface 133a of the extension portion 133 between the inner minimum cross-dimension of the valve opening 111 and the first axial end 102 of the valve body.

Since L1 is greater than L2, when the valve body 132 is pivoted relative to the frame 110 around an end point of the minimum cross-dimension, the trajectory of the valve body 132 is free of interference with the frame 110. Such a feature may advantageously reduce the risk of the valve 130 maintaining a position across the valve opening after release, which may impede pressure relief.

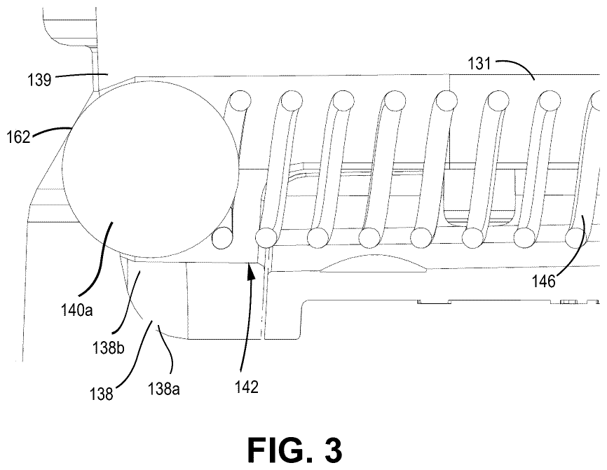

In various embodiments, the extension portion 133 is tapered laterally inward from the inner minimum cross-dimension L1 of the valve opening 111 to the first end 136 of the valve body 132. Such a configuration may advantageously increase the reliability of the release of the valve from the frame upon a minimum pressure differential across the valve body. Correspondingly, a first portion 138a of the first lip 138 can be laterally inward from a second portion 138b of the first lip 138 (best visible in FIG. 3). The first portion 138a of the first lip 138 is positioned towards the first axial end 102 of the pressure relief assembly 100 compared to the second portion 138b of the first lip 138.

There are various factors that help define the minimum pressure differential that removes the valve body 132 from the valve opening 111. The area of the lateral profile of the valve opening 111, the biasing force of the detents 140, the number of detents 140, the contact angle between the detent engagement surface 162/164 and the frame 110, the curvature of the detent engagement surface 162/164, and the length of the lip 138, 139 surrounding the detent engagement surface are all example factors that contribute to defining the minimum pressure differential that removes the valve body 132 from the valve opening 111.

The minimum pressure differential is not particularly limited, but in some embodiments the minimum pressure differential ranges from 40 mbar (0.58 psi) to 100 mbar (1.45 psi), 50 mbar (0.73 psi) to 90 mbar (1.3 psi), or 60 mbar (0.87 psi) to 80 mbar (1.16 psi). In one particular example, the minimum pressure differential ranges from 65 mbar (0.94 psi) to 75 mbar (1.09 psi). However other ranges are certainly contemplated.

In various implementations, the valve body 132 is configured to be clear of the valve airflow pathway 106 upon the minimum pressure differential across the valve opening 111, where being “clear” of the valve airflow pathway 106 means that at least 85%, 90%, 95%, or 97% of the lateral area of the valve opening does not overlap with the lateral area of valve body 132 in the axial direction. In some embodiments, there is no overlap between the lateral area of the valve body 132 and 100% of the lateral area of valve opening in the axial direction. Such a configuration may advantageously maximize pressure release from the enclosure to the outside environment. In some such embodiments, the valve body 132 is configured to be ejected from the frame 110 upon the minimum pressure differential across the valve opening 111. In some embodiments, a tether can couple the valve body 132 to the frame 110 such that the valve body 132 remains in proximity of the frame 110 after detachment from the frame 110.

It has been discovered that eliminating contact between the outer surface of the detent balls 140a, 140b and the channel wall 131 surrounding the detent channel 142 may advantageously increase the reliability of the release of the valve from the frame 110 upon a minimum pressure differential across the valve body 132. Such an example is depicted in FIG. 3, which is a detail view including the first detent engagement surface 162 in FIG. 1. In particular, when the valve body 132 is installed in the frame 110, the frame 110 exerts a compression force on the detent engagement surface 162, 164 and the compression spring 146, which translates the detent engagement surface 162, 164 laterally inward along the detent channel 142, away from the lip 138, 139. As such, there is a gap between the channel wall 131, including at the inner surface of the lip 138, 139, and the outer surface of the detent ball(s) 140a/140b. In some embodiments, there is a gap between the outer surface of the detent ball(s) 140a/140b and the channel wall 131 at least when the environmental temperature is between −40° C. to 125° C. In various embodiments, when the valve 130 is uninstalled in the frame 110, the detent ball 140a, 140b does make contact with the channel wall 131, such as at the inner surface of the lip 138, 139.

The detents 140 can have alternate configurations, as will be appreciated. In some embodiments the detent(s) is not a spring-loaded detent. For example, the detent can be a protrusion extending laterally outward from the valve body 132 or laterally inward from the frame 110 to engage a corresponding engaging surface of the other of the frame 110 or the valve body 132. In some embodiments, each detent is a magnet that secures the valve body 132 to the frame 110.

Some embodiments of the technology disclosed herein may advantageously allow re-use of the pressure relief assembly 100 after release of the valve body 132 from the frame 110. In particular, detents 140 such as spring-loaded detents or magnets, as examples, may be configured to be deployed multiple times without mechanical/physical degradation, which allows for a predictable minimum pressure differential to trigger deployment of the valve body 132. The reusability of the pressure relief assembly 100 may advantageously allow performance testing of every component prior to use by an end customer, for example. The reusability of the pressure relief assembly 100 may advantageously allow re-use by an end customer, as another example.

In the current example, the pressure relief assembly 100 incorporates a vent 150. The valve body 132 defines a vent opening 115 and a vent mounting surface 116 around the vent opening 115. Specifically, the vent opening 115 is the opening in the valve body 132 that abuts the vent 150. A vent airflow pathway is defined through the vent opening 115. The vent 150 is coupled to the vent mounting surface 116 across the vent opening 115. The vent 150 is functionally parallel to the valve 130 relative to airflow through the pressure relief assembly 100. Similarly, the vent airflow pathway is functionally parallel to the valve airflow pathway. “Functionally parallel” is used to mean that airflow can be accommodated through the vent 150 via the vent airflow pathway through vent opening 115 or airflow can bypass the vent airflow pathway by flowing along the valve airflow pathway 106 around the valve body 132, through the valve opening 111. It is noted that the vent opening 115 is not the valve opening 111 despite lateral overlap in the axial direction in this example. It is further noted that, in some embodiments, the pressure relief assembly 100 lacks a vent, however.

In the current example, the valve 130 has a valve sidewall 118 that extends in the axial direction between the first axial end 102 and the second axial end 104. The valve sidewall 118 extends from the vent cover 152 to a vent mounting surface 116. The valve sidewall 118 surrounds the vent mounting surface 116. While the valve sidewall 118 is perpendicular to the valve opening 111, in some embodiments the valve sidewall 118 can form a different angle with the valve opening 111. The valve sidewall 118 defines one or more environmental openings 154. The environmental opening 154 is configured to define the vent airflow pathway between the vent 150 and the external environment. The environmental opening 154 can be perpendicular to the vent 150. The environmental opening 154 can be positioned axially between the vent 150 and the vent cover 152. In the current example, the valve sidewall 118 defines a plurality of environmental openings 154, but in some embodiments the valve sidewall 118 defines a single environmental opening 154. In some embodiments, the environmental openings 154 are spaced around a central axis x. The axis x can be a central axis of the frame 110 in some embodiments.

The term “vent” is used to refer to a component constructed of a breathable material that is configured to facilitate passive airflow. In some such embodiments, the vent 150 allows for venting of an enclosure during normal operation conditions. The vent opening 115 is functionally parallel to the valve opening 111, meaning that the vent opening 115 and the valve opening 111 are arranged in parallel with respect to airflow through the pressure relief assembly 100. The vent opening 115 can also be arranged to be geometrically parallel to the valve opening 111, in some embodiments. In some other embodiments the vent opening 115 is geometrically non-parallel to the valve opening 111, such as where the vent opening 115 is at an angle relative to the valve opening 111.

The vent 150 is coupled to the vent mounting surface 116 across the vent opening 115. The vent 150 is generally configured to prevent the ingress of outside contaminants to the first axial end 102 from the second axial end 104 through the vent opening 115. In various embodiments, the pressure relief assembly 100 lacks a vent in parallel with the valve 130, whether functionally parallel or geometrically parallel.

The vent 150 is generally configured to be positioned in fluid communication with an enclosure that the assembly 100 is coupled to. The vent 150 is configured to allow gases to pass between the enclosure and the environment outside of the enclosure by flowing through vent 150. In some embodiments, the vent 150 is configured to prevent particles from entering into the enclosure. In some embodiments, the vent 150 is also configured to prevent liquids from entering into the enclosure.

The vent 150 can be constructed of a variety of different materials and combinations of materials. In some embodiments the vent 150 is a passive airflow vent, meaning that the vent 150 is configured to passively allow airflow therethrough. In various embodiments the vent 150 incorporates a breathable membrane. In some embodiments, the breathable membrane obstructs the passage of liquid, such as water. Breathable membranes include, for example, polyethersulfone (PES), nylon, cellulose acetate, polyvinylidene difluoride (PVDF), polyamide, polycarbonate, and acrylic. In various embodiments the breathable membrane is constructed of porous polytetrafluoroethylene (PTFE). Porous PTFE can be produced through a variety of approaches and combinations of approaches generally known in the art. The vent 150 can be a laminate or composite that includes a breathable membrane, such as a PTFE membrane laminated to a woven or non-woven support layer. In some embodiments, the vent 150 is a woven fabric or a non-woven fabric. The vent 150 can be constructed of hydrophobic material, or the vent 150 can be treated to exhibit hydrophobic properties. In one example, the vent 150 is a hydrophobic woven or non-woven fabric. The vent 150 can be constructed of an oleophobic material, or the vent 150 can be treated to exhibit oleophobic properties. In one example, the vent 150 is an oleophobic woven or non-woven fabric. In some embodiments the vent 150 has a support ring to support the periphery of the venting material. The vent 150 can be coupled to the frame 110 with adhesive or through a weld area, in examples.

The pressure relief assembly 100 has a vent cover 152 extending laterally across the vent 150 such that the vent 150 is positioned in the axial direction between the vent mounting surface 116 and the vent cover 152. The vent cover 152 is generally spaced in the axial direction from the vent 150. The vent cover 152 can be a separate component that is coupled valve body 132, in some embodiments. In the current example, the vent cover 152 is coupled to the valve sidewall 118. In some other embodiments, the vent cover 152 is a single, cohesive component with the valve sidewall 118, and in such an example, the valve sidewall 118 and the vent cover 152 can be coupled to the valve body 132 around the vent mounting surface 116. The vent cover 152 may advantageously protect the vent 150 from direct impact of environmental contaminants such as liquid spray and debris. As is best visible in FIGS. 1 and 2, an environmental opening 154 can be defined between the vent cover 152 and the vent 150 that is configured to define a vent airflow pathway between the vent 150 and the external environment. The environmental opening 154 can be perpendicular to the vent 150. The environmental opening 154 can be positioned axially between the vent cover 152 and the vent 150. In some embodiments, the assembly 100 lacks a vent cover, such as where the assembly 100 is configured for installation in operating environments where the vent 150 is configured to be relatively protected from impact with environmental contaminants such as water spray and debris.

The coupling structure 120 is generally configured to sealably couple to an enclosure about an enclosure opening, which is not currently depicted. The coupling structure 120 is generally configured to engage the enclosure. In the current example, the coupling structure defines a screw thread configured to be engaged by an enclosure about an enclosure opening. In some embodiments, the coupling structure 120 is defined towards the first axial end 102 of the pressure relief assembly 100.

In some other embodiments, the coupling structure can form a snap-fit connection with the enclosure. In some other embodiments, the coupling structure forms a mating structure that is configured to mate with a corresponding structure defined by the enclosure. For example, the coupling structure 120 has a plurality of fastener receptacles that are each configured to receive a fastener that fastens the pressure relief assembly 100 to the enclosure. Example fasteners include screws, bolts, pins, and the like. As another example, the coupling structure can define a connector that interlocks with the enclosure about the enclosure opening, such as a bayonet connector. In some embodiments, the coupling structure can be coupled to the enclosure around the enclosure opening with an adhesive.

In embodiments consistent with the current example, the pressure relief assembly 100 has a sealing region 124 (best visible in FIG. 1). The sealing region 124 is configured to create a seal between the pressure relief assembly 100 and the enclosure when the pressure relief assembly 100 is coupled to the enclosure. The sealing region 124 generally surrounds a portion of the valve airflow pathway. The sealing region 124 surrounds the valve opening 111 in the example currently depicted. In some embodiments, the sealing region 124 surrounds the coupling structure 120. The sealing region 124 can include an elastomeric material configured to make contact with the enclosure. The sealing region 124 can be defined by the frame 110 itself or it can be a separate component, such as a seal 126. In some other embodiments, the sealing region 124 includes a circumferential groove defined by the frame 110 that is configured to receive a seal 126. In some embodiments the sealing region 124 has the seal 126 that is a loop of rubber or another gasketing or sealing material.

In the current example, the coupling structure 120 includes a threaded portion extending axially from the sealing region 124. The threaded portion is configured to rotatably engage a mating inner circumferential surface of an enclosure about an enclosure opening. In this example, the coupling structure 120 is defined towards the first axial end 102 of the pressure relief assembly 100. The sealing region 124 generally surrounds the valve airflow pathway 106. In the current example, the sealing region 124 surrounds the threaded extension.

In the present example, the frame 110 has a frame sidewall 113. The frame sidewall 113 is positioned radially outward from the valve sidewall 118. The frame sidewall 113 surrounds the valve sidewall 118. In the current example, the valve sidewall 118 and the frame sidewall 113 share the central axis x. In the current example, the valve sidewall 118 and the frame sidewall 113 are spaced via a radial gap between them. In some embodiments, the frame sidewall 113 and the valve sidewall 118 define a tortuous flow path from the outside environment to the vent 150 through the environmental openings 154. As used herein, a “tortuous flow path” refers to a flow path in which there is no direct line of sight to the vent 150 from the second axial end 104. Such configuration may advantageously prevent liquids or debris from directly impacting the vent. In some other embodiments, such as in some other embodiments described elsewhere herein, there is not a tortuous flow path from the outside environment to the vent 150 through the environmental openings 154. In some embodiments, the frame sidewall 113 defines one or more openings.

FIG. 4 depicts another example of a pressure relief assembly 200 consistent with the technology disclosed herein. FIG. 4 is an exploded perspective cross-sectional view of the pressure relief assembly 200. As with the examples discussed above, the pressure relief assembly 200 is generally configured to be coupled to the enclosure about an opening in the enclosure. The pressure relief assembly 200 generally has a first axial end 202, a second axial end 204, and a valve airflow pathway 206 extending from the first axial end 202 through the second axial end 204. The valve airflow pathway 206 is selectively obstructed by a valve 230, where the valve 230 is configured to relieve pressure when the pressure differential between the inside of the enclosure and the outside environment exceeds a minimum pressure differential.

The pressure relief assembly 200 has a frame 210 and the valve 230 is coupled to the frame 210. The frame 210 is generally configured to support one or more components of the pressure relief assembly 200. The frame 210 has a coupling structure 220, a valve mounting surface 212, and a valve opening 211 within the valve mounting surface 212. The valve airflow pathway 206 selectively extends through the valve opening 211. The valve opening 211 extends axially from the valve mounting surface 212. The frame 210 can be consistent with discussions of frames earlier herein.

The valve 230 is generally configured to accommodate pressure release from an enclosure to which the pressure relief assembly 200 is coupled. The valve 230 is generally configured to accommodate pressure release from the first axial end 202 to the second axial end 204 through the frame 210. The valve 230 has a valve body 232 sealably disposed on the valve mounting surface 212 across the valve opening 211. As such, the valve airflow pathway 206 is obstructed by the valve body 232. The valve 230 can generally be consistent with discussions of valves earlier herein.

Unlike the previous example, in the current example the pressure relief assembly 200 has a first detent engagement surface 244 defined by a first detent and a second detent engagement surface 247 defined by a second detent. The first detent engagement surface 244 and the second detent engagement surface 247 each releasably engage the valve body to the frame 210. The first detent engagement surface 244 and the second detent engagement surface 247 are generally configured to release the valve body 232 from the frame 210 upon a minimum pressure differential across the valve opening 211.

In the current example, each detent 240 has a detent housing 242 having a first end 241 and a second end 243. The second end 243 is generally open, and a detent engagement surface 244, 247 extends laterally outwards from the second end 243 of the detent housing 242 to frictionally engage a mating surface of the frame 210 (or the valve body 232 in a reverse orientation). A compression spring 246 is disposed in the detent housing 242, extending from the first end 241 towards the second end 243. The compression spring 246 is compressed between the first end 241 of the detent housing 242 and the detent engagement surface 244. The compression spring 246 biases the detent engagement surface 244 outward. The detent engagement surfaces 244, 247 are translatably disposed relative to the detent housing 242. In the current example, the first detent engagement surface 244 extends laterally outward from the extension portion 233 and the second detent engagement surface 247 extends laterally outward from the extension portion 233. The detent 240, the first detent engagement surface 244 and the second detent engagement surface 247 can be consistent with discussions of vents earlier herein.

The valve 230 may have a plurality of detents 240 including the first detent ball 240a and the second detent ball 240b that releasably secures the valve body 232 to the frame 210. In the current example, the first detent engagement surface 244 is defined by the first detent ball 240a disposed in a detent housing 242, and the second detent engagement surface 247 is defined by the second detent ball 240b disposed in the detent housing 242. The detent balls 240a and 240b can be a sphere translatably disposed in the detent housing 242 to facilitate release of the valve body 232 by the frame 210. The detent ball 240a, 240b can be consistent with discussions of detent balls earlier herein.

In the current example, the detents 240 are disposed around an outer perimetric surface, such as an outer circumferential surface, of the valve body 232. The detent(s) 240 can have a variety of configurations. In the current example, each of the detents 240 is a spring-loaded detent. Each detent 240 extends laterally from the frame 210 to the valve body 232. In the current example, each detent 240 is fixed to the valve body 232 and each detent 240 frictionally engages the frame 210, although the reverse configuration is also possible where each detent 240 is fixed to the frame 210 and frictionally engages the valve body 232. Furthermore, other types of engagement are possible such as magnetic engagement. The detents can have alternative configurations that have been described above.

Unlike the previous example where the valve body defines the detent channel within the channel wall, here the detent housing 242 defines a detent channel 245 within a channel wall 231. The detent 240 is translatably disposed within the detent channel 245. The compression spring 246 is disposed in the first detent housing 242, and the compression spring 246 extends from the first end 241 of the first detent housing 242 towards the open second end 243. The first detent engagement surface 244 is translatably disposed relative to the first detent housing 242. The compression spring is compressibly disposed between the first detent engagement surface and the first end of the first detent housing.

When pressure inside the enclosure spikes above a minimum pressure differential between inside the enclosure and the outside environment, the pressure inside the enclosure pushes against the enclosure side of the valve body 232, which deploys the detent 240 (similar to the discussion above) to decouple the valve body 232 from the valve mounting surface 212. The valve body 232 can either be released from the frame 210 by all of the detents or, can be released by one or more detents and unreleased by one detent such that the valve body pivots in response to the pressure in a direction away from the enclosure to clear the valve airflow pathway 206 and allow pressure equalization between inside the enclosure and the outside environment.

The frame 210 generally has an inner minimum cross-dimension L1 that extends laterally across the valve opening 211. The inner minimum cross-dimension L1 can extend in a direction parallel to the direction from the first detent engagement surface 244 to the second detent engagement surface 247. In embodiments such as that depicted in FIG. 4, the extension portion 233 of the valve body 232 generally has a corresponding cross-dimension that is less than the inner minimum cross-dimension L1 of the valve opening 211. Furthermore, the valve body 232 is generally configured to avoid interference with the frame in the event of a single detent engagement surface 244, 247 disengaging the valve body 232 from the frame 210. In particular, the inner minimum cross-dimension L1 of the valve opening is greater than or equal to the distance L2 from an end point of the inner minimum cross-dimension to the outer surface 233a of the extension portion 233 between the inner minimum cross-dimension of the valve opening 211 and the first axial end 202 of the valve body. The inner minimum cross-dimension L1 and the distance L2 can be consistent with discussions earlier herein.

In various embodiments, the extension portion 233 is tapered laterally inward from the inner minimum cross-dimension L1 of the valve opening 211 to the first end 236 of the valve body 232. The extension portion 233 can be consistent with discussions of vents earlier herein.

In some embodiments, the pressure relief assembly 200 has a first lip 238 surrounding the first detent engagement surface 244. In some embodiments, the pressure relief assembly 200 further has a second lip 239 surrounding the second detent engagement surface 247. The lip 238, 239 is generally configured to retain the detent engagement surface 244,247 relative to the valve body 132. The first detent engagement surface 244 protrudes laterally outward from the first lip 238. The second detent engagement surface 247 protrudes laterally outward from the second lip 239. The lip 238, 239 can be configured to retain the detent engagement surface 244, 247 relative to the valve body 232 particularly when the valve body 232 is uncoupled from the frame 210. In the current example, the lip is defined by a detent housing 242 coupled to the valve body 232. The lip 238, 239 can be consistent with discussions of lips earlier herein.

In some embodiments, similar to the discussions above, when the valve body 232 is installed in the frame 210, the frame 210 exerts a compression force on the detent engagement surface 244, 247 and the compression spring 246, which translates the detent engagement surface 244, 247 laterally inward along the detent channel 245, away from the lip 238, 239. As such, there is a gap between the channel wall 231, including at the inner surface of the lip 238, 239, and the outer surface of the detent ball(s) 140a/140b. Such a configuration can be consistent with discussions earlier herein.

In some embodiments, the valve body 232 is generally configured to be clear of the valve airflow pathway 206 upon the minimum pressure differential across the valve opening 211. Such a configuration can be consistent with valve bodies described in detail above.

In some alternate examples, a single detent can releasably secure a valve body to a frame, and a hinge can pivotably couple the valve body to the frame, such as when the detent releases the valve body from the frame, the valve body pivots about the hinge relative to the frame. In such an example the hinge can define the translation path of the valve body. The hinge is generally configured to accommodate pivoting of the valve body upon the application of pressure on the surface of the valve body in communication with the enclosure, such as the force resulting from a minimum pressure differential across the valve body, and deployment of the detent(s). The valve body is generally pivotable outward relative to the enclosure. In embodiments incorporating a hinge, the hinge can be positioned oppositely of the detents relative to the valve body in the lateral direction. The detent can be consistent with detent discussed elsewhere herein.

### Exemplary Aspects

Aspect 1. A pressure relief assembly comprising:
a frame comprising a coupling structure, a valve mounting surface, and a valve opening within the valve mounting surface, wherein the valve opening extends axially from the valve mounting surface;
a valve comprising a valve body having a sealing rim sealably disposed on the valve mounting surface across the valve opening, wherein the valve body comprises an extension portion extending axially from the sealing rim through the valve opening to a first end of the valve body;
a first detent engagement surface releasably engaging the valve body to the frame;
a second detent engagement surface releasably engaging the valve body to the frame, wherein the second detent engagement surface opposite the first detent engagement surface relative to the valve body,
wherein the frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end.

Aspect 2. The pressure relief assembly of any one of Aspects 1 and 3-21, wherein the first detent engagement surface extends laterally outward from the valve body and releasably engages the frame, and the second detent engagement surface extends laterally outward from the valve body and releasably engages the frame.

Aspect 3. The pressure relief assembly of any one of Aspects 1-2 and 4-21, wherein the extension portion is tapered laterally inward from the valve opening to the first end of the valve body.

Aspect 4. The pressure relief assembly of any one of Aspects 1-3 and 5-21, further comprising a first lip surrounding the first detent engagement surface, wherein the first detent engagement surface protrudes laterally outward from the first lip, the first lip retains the first detent engagement surface relative to the valve body, and a first portion of the first lip is laterally inward from a second portion of the first lip.

Aspect 5. The pressure relief assembly of any one of Aspects 1-4 and 6-21, wherein the first lip is defined by the valve body.

Aspect 6. The pressure relief assembly of any one of Aspects 1-5 and 7-21, wherein the first lip is defined by a detent housing coupled to the valve body.

Aspect 7. The pressure relief assembly of any one of Aspects 1-6 and 8-21, wherein the first portion of the first lip is positioned towards a first axial end of the pressure relief assembly compared to the second portion of the first lip.

Aspect 8. The pressure relief assembly of any one of Aspects 1-7 and 9-21, further comprising a first detent releasably securing the valve body to the frame.

Aspect 9. The pressure relief assembly of any one of Aspects 1-8 and 10-21, wherein the first detent comprises a first detent housing having a first end and an open second end, a compression spring disposed in the first detent housing, the compression spring extending from the first end towards the open second end; and the first detent engagement surface translatably disposed in the first detent housing, wherein the compression spring is compressibly disposed between the first detent engagement surface and the first end of the first detent housing.

Aspect 10. The pressure relief assembly of any one of Aspects 1-9 and 11-21, wherein the valve body comprises a detent opening extending laterally outward from a central axis x, and the first detent is disposed in the detent opening.

Aspect 11. The pressure relief assembly of any one of Aspects 1-10 and 12-21, wherein a compression spring is compressibly disposed between the first detent engagement surface and the second detent engagement surface.

Aspect 12. The pressure relief assembly of any one of Aspects 1-11 and 13-21, further comprising a first detent ball, wherein the first detent ball releasably engages the valve body to the frame, wherein the first detent ball defines an outer surface, wherein the outer surface does not make contact with the valve body.

Aspect 13. The pressure relief assembly of any one of Aspects 1-12 and 14-21, wherein the frame comprises a vent mounting surface, and a vent opening within the vent mounting surface, wherein the vent opening is functionally parallel to the valve opening and the pressure relief assembly further comprises a vent coupled to the vent mounting surface across the vent opening.

Aspect 14. The pressure relief assembly of any one of Aspects 1-13 and 15-21, further comprising a vent, wherein the valve body comprises a vent mounting surface and a vent opening within the vent mounting surface, wherein the vent opening is functionally parallel to the valve opening, and wherein the vent is coupled to the vent mounting surface across the vent opening.

Aspect 15. The pressure relief assembly of any one of Aspects 1-14 and 16-21, wherein the vent opening is geometrically parallel to the valve opening.

Aspect 16. The pressure relief assembly of any one of Aspects 1-15 and 17-21, further comprising a vent cover extending laterally across the vent, wherein the vent is positioned axially between the frame and the vent cover.

Aspect 17. The pressure relief assembly of any one of Aspects 1-16 and 18-21, further defining an environmental opening perpendicular to the vent cover.

Aspect 18. The pressure relief assembly of any one of Aspects 1-17 and 19-21, wherein the environmental opening is positioned axially between the vent cover and the vent.

Aspect 19. The pressure relief assembly of any one of Aspects 1-18 and 20-21, wherein the vent is a breathable membrane.

Aspect 20. The pressure relief assembly of any one of Aspects 1-19 and 21, wherein the valve body has a circular profile in the lateral direction.

Aspect 21. The pressure relief assembly of any one of Aspects 1-20, wherein the valve comprises a valve sidewall around the vent opening and the frame comprises a frame sidewall around the valve opening, wherein the frame sidewall is spaced laterally outward from the valve sidewall.

Aspect 22. A pressure relief assembly comprising:
a frame comprising a coupling structure, a valve mounting surface, and a valve opening within the valve mounting surface, wherein the valve opening extends axially from the valve mounting surface;
a valve comprising a valve body having a sealing rim sealably disposed on the valve mounting surface across the valve opening;
a first detent ball translatably disposed in a detent channel having a channel wall, wherein the first detent ball releasably engages the valve body to the frame, wherein the first detent ball defines an outer surface, wherein the outer surface does not make contact with the channel wall.

Aspect 23. The pressure relief assembly of any one of Aspects 22 and 24-45, wherein the valve body comprises an extension portion extending axially from the sealing rim through the valve opening to a first end of the valve body.

Aspect 24. The pressure relief assembly of any one of Aspects 22-23 and 25-45, further comprising a first detent engagement surface releasably engaging the valve body to the frame.

Aspect 25. The pressure relief assembly of any one of Aspects 22-24 and 26-45, further comprising a second detent engagement surface releasably engaging the valve body to the frame, wherein the second detent engagement surface opposite the first detent engagement surface relative to the valve body.

Aspect 26. The pressure relief assembly of any one of Aspects 22-25 and 27-45, wherein the frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end.

Aspect 27. The pressure relief assembly of any one of Aspects 22-26 and 28-45, wherein the first detent engagement surface extends laterally outward from the valve body and releasably engages the frame, and the second detent engagement surface extends laterally outward from the valve body and releasably engages the frame.

Aspect 28. The pressure relief assembly of any one of Aspects 22-27 and 29-45, wherein the extension portion is tapered laterally inward from the valve opening to the first end of the valve body.

Aspect 29. The pressure relief assembly of any one of Aspects 22-28 and 30-45, further comprising a first lip surrounding the first detent engagement surface, wherein the first detent engagement surface protrudes laterally outward from the first lip, the first lip retains the first detent engagement surface relative to the valve body, and a first portion of the first lip is laterally inward from a second portion of the first lip.

Aspect 30. The pressure relief assembly of any one of Aspects 22-29 and 31-45, wherein the first lip is defined by the valve body.

Aspect 31. The pressure relief assembly of any one of Aspects 22-30 and 32-45, wherein the first lip is defined by a detent housing coupled to the valve body.

Aspect 32. The pressure relief assembly of any one of Aspects 22-31 and 33-45, wherein the first portion of the first lip is positioned towards a first axial end of the pressure relief assembly compared to the second portion of the first lip.

Aspect 33. The pressure relief assembly of any one of Aspects 22-32 and 34-45, further comprising a first detent releasably securing the valve body to the frame.

Aspect 34. The pressure relief assembly of any one of Aspects 22-33 and 35-45, wherein the first detent comprises a first detent housing having a first end and an open second end, a compression spring disposed in the first detent housing, the compression spring extending from the first end towards the open second end; and the first detent engagement surface translatably disposed in the first detent housing, wherein the compression spring is compressibly disposed between the first detent engagement surface and the first end of the first detent housing.

Aspect 35. The pressure relief assembly of any one of Aspects 22-34 and 36-45, wherein the valve body comprises a detent opening extending laterally outward from a central axis x, and the first detent is disposed in the detent opening.

Aspect 36. The pressure relief assembly of any one of Aspects 22-35 and 37-45, wherein a compression spring is compressibly disposed between the first detent engagement surface and the second detent engagement surface.

Aspect 37. The pressure relief assembly of any one of Aspects 22-36 and 38-45, wherein the frame comprises a vent mounting surface, and a vent opening within the vent mounting surface, wherein the vent opening is functionally parallel to the valve opening and the pressure relief assembly further comprises a vent coupled to the vent mounting surface across the vent opening.

Aspect 38. The pressure relief assembly of any one of Aspects 22-37 and 39-45, further comprising a vent, wherein the valve body comprises a vent mounting surface and a vent opening within the vent mounting surface, wherein the vent opening is functionally parallel to the valve opening, and wherein the vent is coupled to the vent mounting surface across the vent opening.

Aspect 39. The pressure relief assembly of any one of Aspects 22-38 and 40-45, wherein the vent opening is geometrically parallel to the valve opening.

Aspect 40. The pressure relief assembly of any one of Aspects 22-39 and 41-45, further comprising a vent cover extending laterally across the vent, wherein the vent is positioned axially between the frame and the vent cover.

Aspect 41. The pressure relief assembly of any one of Aspects 22-40 and 42-45, further defining an environmental opening perpendicular to the vent cover.

Aspect 42. The pressure relief assembly of any one of Aspects 22-41 and 43-45, wherein the environmental opening is positioned axially between the vent cover and the vent.

Aspect 43. The pressure relief assembly of any one of Aspects 22-42 and 44-45, wherein the vent is a breathable membrane.

Aspect 44. The pressure relief assembly of any one of Aspects 22-43 and 45, wherein the valve body has a circular profile in the lateral direction.

Aspect 45. The pressure relief assembly of any one of Aspects 22-44, wherein the valve comprises a valve sidewall around the vent opening and the frame comprises a frame sidewall around the valve opening, wherein the frame sidewall is spaced laterally outward from the valve sidewall.

Aspect 46. A pressure relief assembly comprising:
a valve comprising a valve body having a sealing rim sealably configured to seal across a valve opening, wherein the valve body defines a detent channel extending laterally across the valve body;
a spring disposed in the detent channel, the spring defining a first end and a second end; and
a first detent ball and a second detent ball opposite the first detent ball relative to the valve body, wherein the spring is compressibly disposed between the first detent ball and the second detent ball.

Aspect 47. The pressure relief assembly of any one of Aspects 46 and 48-57, further comprising:
a frame comprising a coupling structure, a valve mounting surface, and the valve opening within the valve mounting surface, wherein the valve opening extends axially from the valve mounting surface, wherein the sealing rim is sealably disposed on the valve mounting surface across the valve opening, and wherein the first detent ball and the second detent ball releasably engages the frame.

Aspect 48. The pressure relief assembly of any one of Aspects 46-47 and 49-57, wherein the valve body comprises a vent mounting surface and a vent opening within the vent mounting surface, and the pressure relief assembly further comprises a vent coupled to the vent mounting surface across the vent opening.

Aspect 49. The pressure relief assembly of any one of Aspects 46-48 and 50-57, further comprising a vent cover extending laterally across the vent, wherein the vent is positioned axially between the vent and the vent cover.

Aspect 50. The pressure relief assembly of any one of Aspects 46-49 and 51-57, wherein the valve comprises a valve sidewall around the vent opening and the frame comprises a frame sidewall around the valve opening, wherein the frame sidewall is spaced laterally outward from the valve sidewall.

Aspect 51. The pressure relief assembly of any one of Aspects 46-50 and 52-57, wherein the valve body comprises an extension portion extending axially from the sealing rim to a first end of the valve body, and wherein the extension portion defines the detent channel.

Aspect 52. The pressure relief assembly of any one of Aspects 46-51 and 53-57, wherein the frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end.

Aspect 53. The pressure relief assembly of any one of Aspects 46-52 and 54-57, wherein the outer surface of the first detent ball and the second detent ball does not make contact with a channel wall defining the detent channel.

Aspect 54. The pressure relief assembly of any one of Aspects 46-53 and 55-57, wherein the extension portion is tapered laterally inward from the valve opening to the first end of the valve body.

Aspect 55. The pressure relief assembly of any one of Aspects 46-54 and 56-57, wherein the first detent ball defines a first detent engagement surface, and the assembly further comprises a first lip surrounding the first detent engagement surface, wherein the first detent engagement surface protrudes laterally outward from the first lip, the first lip retains the first detent engagement surface relative to the valve body, and a first portion of the first lip is laterally inward from a second portion of the first lip.

Aspect 56. The pressure relief assembly of any one of Aspects 46-55 and 57, wherein the first lip is defined by the valve body.

Aspect 57. The pressure relief assembly of any one of Aspects 46-56, wherein the first portion of the first lip is positioned towards a first axial end of the pressure relief assembly compared to the second portion of the first lip.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A pressure relief assembly comprising:
a frame comprising a coupling structure, a valve mounting surface, and a valve opening within the valve mounting surface, wherein the valve opening extends axially from the valve mounting surface;
a valve comprising a valve body having a sealing rim sealably disposed on the valve mounting surface across the valve opening, wherein the valve body comprises an extension portion extending axially from the sealing rim through the valve opening to a first end of the valve body;
a first detent engagement surface releasably engaging the valve body to the frame; and
a second detent engagement surface releasably engaging the valve body to the frame,
wherein the second detent engagement surface opposite the first detent engagement surface relative to the valve body,
wherein the frame has an inner minimum cross-dimension across the valve opening that is greater than or equal to a distance from an end point of the inner minimum cross-dimension laterally across the valve opening to an outer surface of the extension portion between the inner minimum cross-dimension of the valve opening and the first end.

2. The pressure relief assembly of claim 1, wherein the first detent engagement surface extends laterally outward from the valve body and releasably engages the frame, and the second detent engagement surface extends laterally outward from the valve body and releasably engages the frame.

3. The pressure relief assembly of claim 1, wherein the extension portion is tapered laterally inward from the valve opening to the first end of the valve body.

4. The pressure relief assembly of claim 1, further comprising a first lip surrounding the first detent engagement surface, wherein the first detent engagement surface protrudes laterally outward from the first lip, the first lip retains the first detent engagement surface relative to the valve body, and a first portion of the first lip is laterally inward from a second portion of the first lip.

5. The pressure relief assembly of claim 4, wherein the first lip is defined by the valve body.

6. The pressure relief assembly of claim 4, wherein the first lip is defined by a detent housing coupled to the valve body.

7. The pressure relief assembly of claim 4, wherein the first portion of the first lip is positioned towards a first axial end of the pressure relief assembly compared to the second portion of the first lip.

8. The pressure relief assembly of claim 1, further comprising a first detent releasably securing the valve body to the frame.

9. The pressure relief assembly of claim 8, wherein the first detent comprises a first detent housing having a first end and an open second end, a compression spring disposed in the first detent housing, the compression spring extending from the first end towards the open second end; and the first detent engagement surface translatably disposed in the first detent housing, wherein the compression spring is compressibly disposed between the first detent engagement surface and the first end of the first detent housing.

10. The pressure relief assembly of claim 8, wherein the valve body comprises a detent opening extending laterally outward from a central axis x, and the first detent is disposed in the detent opening.

11. The pressure relief assembly of claim 1, wherein a compression spring is compressibly disposed between the first detent engagement surface and the second detent engagement surface.

12. The pressure relief assembly of claim 1, further comprising a first detent ball, wherein the first detent ball releasably engages the valve body to the frame, wherein the first detent ball defines an outer surface, wherein the outer surface does not make contact with the valve body.

13. The pressure relief assembly of claim 1, wherein the frame comprises a vent mounting surface, and a vent opening within the vent mounting surface, wherein the vent opening defines a vent airflow pathway that is functionally parallel to a valve airflow pathway through the valve opening and the pressure relief assembly further comprises a vent coupled to the vent mounting surface across the vent opening.

14. The pressure relief assembly of claim 1, further comprising a vent, wherein the valve body comprises a vent mounting surface and a vent opening within the vent mounting surface, wherein the vent opening defines a vent airflow pathway that is functionally parallel to a valve airflow pathway through the valve opening, and wherein the vent is coupled to the vent mounting surface across the vent opening.

15. The pressure relief assembly of claim 14, further comprising a vent cover extending laterally across the vent, wherein the vent is positioned axially between the frame and the vent cover.

16. The pressure relief assembly of claim 15, further defining an environmental opening perpendicular to the vent cover.

17. The pressure relief assembly of claim 16, wherein the environmental opening is positioned axially between the vent cover and the vent.

18. The pressure relief assembly of claim 13, wherein the valve comprises a valve sidewall around the vent opening and the frame comprises a frame sidewall around the valve opening, wherein the frame sidewall is spaced laterally outward from the valve sidewall.

19. A pressure relief assembly comprising:
a frame comprising a coupling structure, a valve mounting surface, and a valve opening within the valve mounting surface, wherein the valve opening extends axially from the valve mounting surface;
a valve comprising a valve body having a sealing rim sealably disposed on the valve mounting surface across the valve opening;
a first detent ball translatably disposed in a detent channel having a channel wall,
wherein the first detent ball releasably engages the valve body to the frame, wherein the first detent ball defines an outer surface, wherein the outer surface does not make contact with the channel wall.

20. A pressure relief assembly comprising:
a valve comprising a valve body having a sealing rim sealably configured to seal across a valve opening, wherein the valve body defines a detent channel extending laterally across the valve body;
a spring disposed in the detent channel, the spring defining a first end and a second end; and
a first detent ball and a second detent ball opposite the first detent ball relative to the valve body, wherein the spring is compressibly disposed between the first detent ball and the second detent ball.
